(19) United States
(12) Patent Application Publication
(10) Pub. No.: US 2026/0343631 A1
(43) Pub. Date: Oct. 29, 2026

(54) COMMUNICATION METHOD, ELECTRONIC DEVICE AND STORAGE MEDIUM

(71) Applicant: BEIJING XIAOMI MOBILE SOFTWARE CO., LTD., Beijing (CN)

(72) Inventor: Xiandong DONG, Beijing (CN)

(73) Assignee: BEIJING XIAOMI MOBILE SOFTWARE CO., LTD., Beijing (CN)

(21) Appl. No.: 19/146,242

(22) PCT Filed: Jan. 9, 2023
(86) PCT No.: PCT/CN2023/071445

§ 371 Date: Jul. 8, 2025

(51) Int. Cl. H04W 76/10; H04L 43/12; H04W 8/22

(52) U.S. Cl. CPC H04W 76/10; H04L 43/12; H04W 8/22

(57) ABSTRACT

A communication method, performed by a first access point (AP), includes: determining a first wireless frame; in which the first wireless frame includes initial access parameter information of a second AP; and sending the first wireless frame.

### CROSS-REFERENCE TO RELATED APPLICATIONS

This application is a U.S. National Phase of International Application No. PCT/CN2023/071445, filed on Jan. 9, 2023, the entire content of which is incorporated herein by reference.

### TECHNICAL FIELD

Embodiments of the disclosure relate to a field of mobile communication technologies, and particularly to a communication method, an electronic device, and a storage medium.

### BACKGROUND

With the rapid development of mobile communication technologies, wireless fidelity (Wi-Fi) technologies achieve a great progress in a transmission rate and a throughput. Presently, contents researched in the Wi-Fi technologies, such as an ultra high reliability (UHR), are aimed at improving a reliability of a wireless local area network (WLAN) connection, reducing a delay, improving a manageability, increasing throughputs at different signal-to-noise ratio (SNR) levels and reducing a device-level power consumption. Moreover, in the UHR, in order to improve the throughput of the system, there is provided a simultaneous communication way in a sub-7 GHz frequency band, and 45 GHz and/or 60 GHz frequency bands.

In the UHR, a transmission mechanism of a low-latency service may be further enhanced, and a multi-link scenario may be supported. In order to ensure the transmission of the low-latency service, a station (STA) may perform handover between multiple access points (AP). Therefore, there needs to provide a mechanism to support the STA performing handover between the multiple AP devices, to meet a transmission requirement of the UHR.

### SUMMARY

In a first aspect, embodiments of the disclosure provide a communication method, applied to a first AP. The communication method includes:
determining a first wireless frame; in which the first wireless frame includes initial access parameter information of a second AP; and
sending the first wireless frame.

In a second aspect, embodiments of the disclosure also provide a communication method, applied to an STA. The communication method includes:
receiving a first wireless frame sent by a first AP; in which the first wireless frame includes initial access parameter information of a second AP.

In a third aspect, embodiments of the disclosure also provide a first AP. The first AP includes: a processor; and a memory storing executable instructions by the processor. The processor is configured to execute the method in the first aspect.

In a fourth aspect, embodiments of the disclosure also provide an STA. The STA includes: a processor; and a memory storing executable instructions by the processor. The processor is configured to execute the method in the second aspect.

In a fifth aspect, embodiments of the disclosure also provide a non-transitory computer-readable storage medium. A computer program is stored on the computer-readable storage medium, and the computer program is configured to realize the communication method in the first aspect when executed by a processor.

In a sixth aspect, embodiments of the disclosure also provide a non-transitory computer-readable storage medium. A computer program is stored on the computer-readable storage medium. The computer program is configured to realize the communication method in the second aspect when executed by a processor.

### BRIEF DESCRIPTION OF THE DRAWINGS

In order to more clearly illustrate embodiments of the disclosure, embodiments or accompanying drawings needed to use in the description of embodiments of the disclosure will be introduced clearly below. The accompanying drawings described below are only some of embodiments of the disclosure. For the ordinary skilled in the art, other drawings may further be obtained based on these accompanying drawings without creative work.

FIG. 1 is a first flow chart illustrating a communication method according to embodiments of the disclosure.

FIG. 2 is a first schematic diagram illustrating a first example of embodiments of the disclosure.

FIG. 3 is a second schematic diagram illustrating a first example of embodiments of the disclosure.

FIG. 4 is a second flow chart illustrating a communication method according to embodiments of the disclosure.

FIG. 5 is a first block diagram illustrating an electronic device according to embodiments of the disclosure.

FIG. 6 is a second block diagram illustrating an electronic device according to embodiments of the disclosure.

FIG. 7 is a third block diagram illustrating an electronic device according to embodiments of the disclosure.

### DETAILED DESCRIPTION

Reference will now be made in detail to exemplary embodiments, examples of which are illustrated in the accompanying drawings. The following description refers to the accompanying drawings in which same numbers in different accompanying drawings represent same or similar elements unless otherwise represented. The implementations set forth in the following description of exemplary embodiments do not represent all implementations consistent with the disclosure. Instead, they are merely examples of apparatuses and methods consistent with aspects related to the disclosure as recited in the appended claims.

The term employed in embodiments of the disclosure is merely for the purpose of describing a specific embodiment, and is not intended to limit the disclosure. As used in the disclosure and the appended claims, a singular form “a” or “the” is also intended to include plural forms, unless the context clearly indicates other meaning. It should also be understood that, the term “and/or” as used herein refers to including any or all possible combinations of one or more associated listed items. For example, A and/or B may represent three cases, that is, A alone, A and B simultaneously, and B alone. The character “/” generally represents that context objects are an “or” relationship. A term herein “a/the plurality of” or “multiple” refers to two or more. In view of this, “multiple” can also be understood as “at least two” in embodiment of this disclosure.

It should be understood that, although terms “first, second, third and the like” may be employed in the disclosure to describe various kinds of information, the information should not be limited to these terms. These terms are merely used to distinguish a same type of information from each other. For example, without departing from a scope of the disclosure, first information may also be called second information, and similarly, the second information may also be called first information. Depending on the context, the word “if” as used herein may be interpreted as “when” or “in a case that . . . ” or “in response to determining”.

A technical solution in embodiments of the disclosure will be clearly and completely described below with reference to the accompanying drawings. Obviously, the described embodiments are only some of embodiments of the disclosure, but not all the embodiments. Based on embodiments in the disclosure, all other embodiments obtained by ordinary skilled in the art without creative work belong to the scope of protection in the disclosure.

Embodiments of the disclosure provide a communication method, an electronic device and a storage medium, which are used to provide a mechanism to support an STA performing handover between multiple APs, to meet a transmission requirement of an UHR.

The method and the apparatus are based on the same application concept. Because the principles of solving problems in the method and the apparatus are similar, the implementation of the apparatus and the method may be referred to each other, and the repetition is not repeated here.

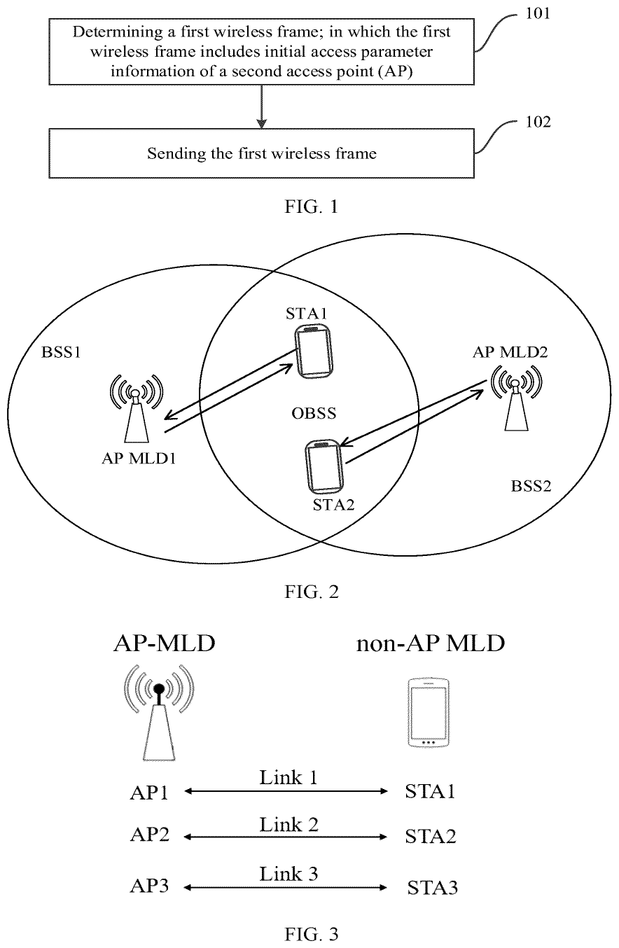

As illustrated in FIG. 1, embodiments of the disclosure provide a communication method. Alternatively, the method may be applied to a first AP. Alternatively, in embodiments of the disclosure, the AP is, such as, a device with a wireless-to-wired bridging function, and the AP is responsible for extending a service provided by a wired network to a wireless network. An STA, such as, an electronic device with a wireless network access function, provides a frame delivery service to enable information to be delivered.

The method may include the following.

At block 101, a first wireless frame is determined; in which the first wireless frame includes initial access parameter information of a second AP;

In a wireless local area network, one basic service set (BSS) may be constituted by the AP and one or more station (STAs) communicating with the AP. One basic service set may be connected to a distribution system (DS) through the AP and then connected to another basic service set, to form an extended service set (ESS). As a first example, referring to FIG. 2, an AP1 and an STA1 constitute a BSS1, and an AP2 and an STA2 constitute a BSS2. When a coverage areas of two or more BSSs overlap, an overlapping basic service set (OBSS) are formed. As illustrated in FIG. 2, the BSS1 and the BSS2 overlap to form the OBSS.

Alternatively, in embodiments of the disclosure, the AP and the STA may be devices supporting multiple links, for example, respectively represented as an AP MLD and a non-AP MLD. The AP MLD may represent an access point supporting multi-link communication function, and the non-AP MLD may represent a station supporting the multi-link communication function.

Referring to FIG. 3, the AP MLD may include three affiliated APs, such as an AP1, an AP2 and an AP3 as illustrated in FIG. 3. Each AP may work in a link 1, a link 2 and a link 3 respectively. The non-AP MLD may also include three affiliated STAs, such as an STA1, an STA2 and an STA3 as illustrated in FIG. 3. The STA1 works in the link 1, STA2 works in the link 2, and the STA3 works in the link 3.

For convenience of description, an example that one AP communicates with one STA in the multiple links is mainly described below, however, example embodiments of the disclosure are not limited to this. In the example of FIG. 3, it is assumed that the AP1 and the STA1 communicate through a first link 1, similarly, the AP2 and the STA2 communicate through a second link 2, and the AP communicates with the STA3 through the third link 3. In addition, the link 1 to link 3 may be multiple links at different frequencies, for example, links at 2.4 GHz, 5 GHz and 6 GHz, or several links at 2.4 GHz with the same or different bandwidths. In addition, multiple channels may exist under each link. It may be understood that a communication scenario illustrated in FIG. 2 is only exemplary, and the concept of the disclosure is not limited to this. For example, an AP MLD may be connected to multiple (e.g., three) non-AP MLDs, or an AP may communicate with other multiple types of stations under each link.

It may be understood that, in embodiments of the disclosure, the AP may be the AP MLD, and the STA may be an STA MLD. For convenience of explanation, the AP and the STA are introduced below, but does not constitute a limitation to embodiments of the disclosure.

In the UHR, the STA may perform handover between multiple APs. For example, when a communication condition of the AP associated with the STA changes, the STA may perform handover to another AP for communication, such that a flow is not stopped in the data transmission. In embodiments of the disclosure, in order to realize seamless data connection, the first AP determines the first wireless frame, and the first wireless frame carries the initial access parameter information of the second AP, such that the STA may access the second AP based on the initial access parameter information in a scenario where the STA needs to perform handover to the second AP. Alternatively, the initial access parameter information of the second AP may be obtained by the first AP from a beacon frame, a probe response frame, an association response frame or the like broadcasted by the second AP.

Alternatively, the first AP may be the AP that the STA is currently connected to in communication, there may be multiple second APs, and the second AP and the first AP do not belong to the same AP MLD. The first AP sends the initial access parameter information (or initial association parameter information) of one or more second APs to the STA, such that the STA may complete the initial access (or association) with the second AP in time based on the initial access parameter information when the communication condition between the STA and the first AP changes, and transmit service data through the second AP, to avoid data interruption and ensure the transmission of the low-delay service.

At block 102, the first wireless frame is sent.

Alternatively, in embodiments of the disclosure, the first wireless frame includes at least one of:
the beacon frame, the probe response frame, or the association response frame. The first AP carries the initial access parameter information of the one or more second APs in the first wireless frame. When the communication condition of the AP associated with the STA changes, the handover may be performed to another AP for communication, such that a flow is not stopped in the data transmission, to meet the requirement of the UHR for the transmission rate and the requirement of the low-delay service for the time delay.

Embodiments of the disclosure provides a communication method, applied to a first AP. The method includes:
determining a first wireless frame; in which the first wireless frame includes initial access parameter information of a second AP, the initial access parameter information includes at least one of medium access control (MAC) address information of the second AP or a work link parameter of the second AP, and the work link parameter is, such as, a link identification (ID) or an MAC address of a work link of the second AP; and
sending the first wireless frame.

For other content, please refer to the related contents of the above embodiments, which is not repeated here.

Embodiments of the disclosure provide a communication method, applied to a first AP. The method includes:
determining a first wireless frame; in which the first wireless frame includes initial access parameter information of a second AP, the initial access parameter information includes at least one of medium access control (MAC) address information of the second AP or a work link parameter of the second AP, and the work link parameter is, such as, a link ID or a link MAC address of a work link of the second AP; and
sending the first wireless frame.

In the case that the second AP does not support multi-link communication (the first AP may or may not support the multi-link communication), the initial access parameter information includes: the MAC address of the second AP; a BSS parameter of the second AP, for example, an information value such as a BSSID; and the work link parameter of the second AP. The work link parameter is, such as, the link ID, the link MAC address, and the like of the work link of the second AP.

For other content, please refer to the related contents of the above embodiments, which is not repeated here.

Embodiments of the disclosure provide a communication method, applied to a first AP. The method includes:
determining a first wireless frame; in which the first wireless frame includes initial access parameter information of a second AP, the initial access parameter information includes at least one of: MAC address information of the second AP, a work link parameter, or the like of the second AP; and
sending the first wireless frame.

The second AP supports multi-link communication (the first AP may or may not support the multi-link communication), and the initial access parameter information includes a station information parameter of the second AP. The work link parameter of the second AP is carried in the station information parameter.

Alternatively, the first AP may also support non-simultaneous transmitting and receiving (NSTR) or simultaneous transmitting and receiving (STR).

Alternatively, the second AP may also support non-simultaneous transmitting and receiving (NSTR) or simultaneous transmitting and receiving (STR).

For other content, please refer to the related contents of the above embodiments, which is not repeated here.

In an alternative embodiment, the work link parameter of the second AP includes at least one of:
a link identification (ID) of a work link of the second AP, or an MAC address of the work link of the second AP. For example, the first wireless frame includes an STA info domain. The STA info domain includes the link ID and the link MAC address of each work link of the second AP, in which the link ID of the work link of the second AP may overlap with the link ID of the work link of the first AP.

In an alternative embodiment, the method also includes:
sending device information of a first station to the second AP, in which the first station is a station that establishes a link with the first AP.

After establishing the link with the STA, the first AP shares the device information of all the first STAs with which the first AP establishes the link, with other AP (such as the second AP), such that the second AP establishes a link with the first STA based on the device information of the first station shared by the first AP.

For other content, please refer to the related contents of the above embodiments, which is not repeated here.

Alternatively, the device information of the first station includes at least one of:

MAC address information of the first station, MAC address information of a multi-link device to which the first station belongs, or work link information of the first station

In the case that the first STA does not support multi-link communication, the MAC address information and the work link information of the first STA may be sent to other APS. In the case that the first STA supports the multi-link communication, the MAC address information of the multi-link device to which the first STA belongs and the work link information of the first STA may be sent to other AP. The work link information includes, such as, a link ID and a link MAC address; may also include maximum bandwidth information supported under a connection corresponding to each link ID, such as 160 MHz; may also include supported modulation and coding (MCS) way, a spatial stream (SS) and other information.

Embodiments of the disclosure provide a communication method, applied to a first AP. The method includes:
receiving a probe request frame sent by a second station; in which the probe request frame includes first identification information, and the first identification information indicates the second station requesting to obtain the device information of the first AP and device information of the second AP.
determining a first wireless frame; in which the first wireless frame includes initial access parameter information of a second AP; and
sending the first wireless frame.

The second STA may actively send the probe request frame, and the first identification information may be carried in the probe request frame, and the first identification information indicates the second STA requesting to obtain the initial access parameter information of the first AP and the second AP. The first AP determines the first wireless frame after receiving the probe request frame, and carries the initial access parameter information of the second AP in the first wireless frame.

For other content, please refer to the related contents of the above embodiments, which is not repeated here.

Embodiments of the disclosure provide a communication method, applied to a first AP. The method includes:
determining a first wireless frame; in which the first wireless frame includes initial access parameter information of a second AP; and sending the first wireless frame.

Alternatively, the initial access parameter information includes at least one of:

MAC address information of the second AP, or a work link parameter of the second AP.

Alternatively, the second AP does not support multi-link communication, and the initial access parameter information includes a BSS parameter of the second AP.

Alternatively, the second AP supports multi-link communication, and the initial access parameter information includes a station information parameter of the second AP; and the work link parameter of the second AP is carried in the station information parameter.

Alternatively, the work link parameter of the second AP includes at least one of:
a link ID of a work link of the second AP, or an MAC address of the work link of the second AP.

Alternatively, the communication method also includes:
sending device information of a first station establishing a link with the first AP to the second AP.

Alternatively, the device information of the first station includes at least one of:

MAC address information of the first station, MAC address information of a multi-link device to which the first station belongs, or work link information of the first station.

Alternatively, the communication method also includes:
receiving a probe request frame sent by a second station; in which the probe request frame includes first identification information, and the first identification information indicates the second station requesting to obtain the device information of the first AP and device information of the second AP.

Alternatively, the first wireless frame includes at least one of:
a beacon frame, a probe response frame, or an association response frame.

For other content, please refer to the related contents of the above embodiments, which is not repeated here.

In embodiments of the disclosure, the first AP carries the initial access parameter information of one or more second APS in the first wireless frame, such that the STA may perform handover to another AP for communication when the communication condition of the AP associated with the STA changes, and a flow is not stopped in the data transmission, to meet the requirement of the UHR for the transmission rate and the requirement of the low-delay service for the time delay.

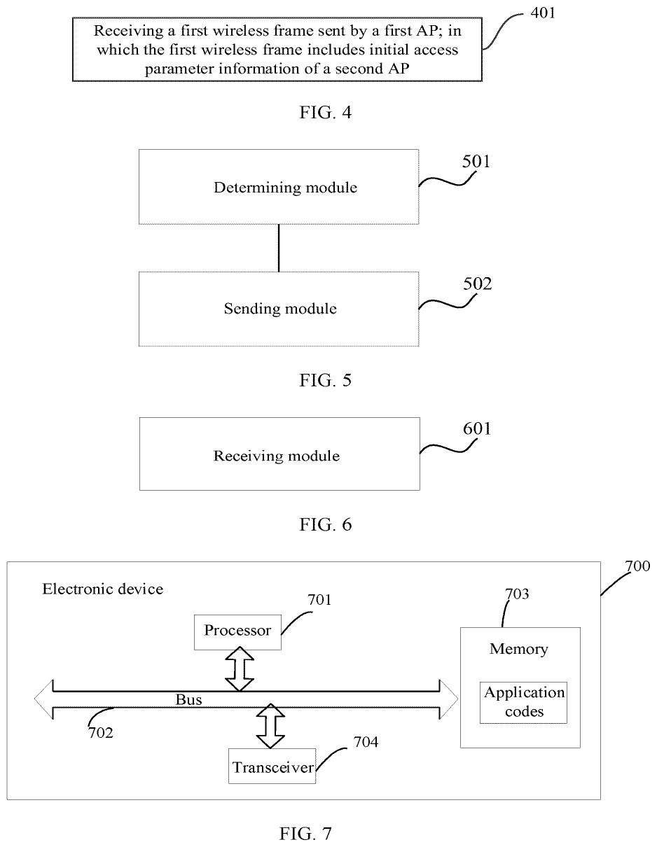

Referring to FIG. 4, embodiments of the disclosure provide a communication method. Alternatively, the method may be applied to an STA. The method includes the following.

At block 401, a first wireless frame sent by a first AP is received; in which the first wireless frame includes initial access parameter information of a second AP.

A WLAN architecture applied by the communication method according to embodiments of the disclosure refers to the above first example, which is not repeated here.

In the UHR, the STA may perform handover between multiple APs. For example, when a communication condition between the STA and the AP associated with the STA changes, handover may be performed to another AP for communication, such that a flow is not stopped in the data transmission. In embodiments of the disclosure, in order to realize seamless data connection, the first AP carries the initial access parameter information of the second AP in the first wireless frame, such that the STA accesses the second AP based on the initial access parameter information in a scenario where the STA needs to perform handover to the second AP. Alternatively, the initial access parameter information of the second AP may be obtained by the first AP from a beacon frame, a probe response frame, an association response frame or the like broadcasted by the second AP.

Alternatively, the first AP may be the AP that the STA is currently connected to in communication, there may be multiple second APs, and the second AP and the first AP do not belong to the same AP MLD. The first AP sends the initial access parameter information (or initial association parameter information) of one or more second APs to the STA, such that the STA may complete the initial access (or association) with the second AP in time based on the initial access parameter information when the communication condition between the STA and the first AP changes, and transmit service data through the second AP, to avoid data interruption and ensure the transmission of the low-delay service.

Alternatively, in embodiments of the disclosure, the first wireless frame includes at least one of:
the beacon frame, the probe response frame, or the association response frame.

The first AP carries the initial access parameter information of the one or more second APs in the first wireless frame. When the communication condition of the AP associated with the STA changes, handover may be performed to another AP for communication, such that a flow is not stopped in the data transmission, to meet the requirement of the UHR for the transmission rate and the requirement of the low-delay service for the time delay.

Embodiments of the disclosure provide a communication method. Alternatively, the method may be applied to an STA. The method includes:
receiving a first wireless frame sent by a first AP; in which the first wireless frame includes initial access parameter information of a second AP.

The initial access parameter information includes at least one of:

MAC address information of the second AP, or a work link parameter of the second AP. The work link parameter is, such as, a link ID or a link MAC address of a work link of the second AP

Embodiments of the disclosure provide a communication method. Alternatively, the method may be applied to an STA. The method includes:
receiving a first wireless frame sent by a first AP; in which the first wireless frame includes initial access parameter information of a second AP.

The second AP does not support multi-link communication, and the initial access parameter information includes a BSS parameter of the second AP.

In the case that the second AP does not support multi-link communication (the first AP may or may not support the multi-link communication), the initial access parameter information includes: the MAC address of the second AP; the BSS parameter of the second AP, for example, an information value such as a BSSID; and the work link parameter of the second AP. The work link parameter is, such as, the link ID, the link MAC address, and the like of the work link of the second AP.

Embodiments of the disclosure provide a communication method. Alternatively, the method may be applied to an STA. The method includes:
receiving a first wireless frame sent by a first AP; in which the first wireless frame includes initial access parameter information of a second AP.

The second AP supports multi-link communication, and the initial access parameter information includes a station information parameter of the second AP; and
the work link parameter of the second AP is carried in the station information parameter.

The second AP supports the multi-link communication (the first AP may or may not support the multi-link communication), and the initial access parameter information includes a station information parameter of the second AP. The work link parameter of the second AP is carried in the station information parameter.

In an alternative embodiment, the work link parameter of the second AP includes at least one of:
a link identification (ID) of a work link of the second AP, or an MAC address of the work link of the second AP. For example, the first wireless frame includes an STA info domain. The STA info domain includes the link ID and the link MAC address of each work link of the second AP, in which the link ID of the work link of the second AP may overlap with the link ID of the work link of the first AP.

Embodiments of the disclosure provide a communication method. Alternatively, the method may be applied to an STA. The method includes:
determining a probe request frame, in which the probe request frame includes first identification information, and the first identification information indicates the station requesting to obtain the device information of the first AP and device information of the second AP;
sending the probe request frame; and
receiving a first wireless frame sent by a first AP; in which the first wireless frame includes initial access parameter information of a second AP.

The second STA may actively send the probe request frame, and the first identification information may be carried in the probe request frame, and the first identification information indicates the second STA requesting to obtain the initial access parameter information of the first AP and the second AP. The first AP determines the first wireless frame after receiving the probe request frame, and carries the initial access parameter information of the second AP in the first wireless frame.

Embodiments of the disclosure provide a communication method. Alternatively, the method may be applied to an STA. The method includes:
receiving a first wireless frame sent by a first AP; in which the first wireless frame includes initial access parameter information of a second AP; and
establishing an initial link with the first AP or the second AP based on the first wireless frame.

The STA may establish an initial association with the first AP based on the first wireless frame after receiving the first wireless frame. Alternatively, when the communication condition of the first AP associated with the STA changes, the STA may perform handover to the second AP for communication, and establish an initial association with the second AP.

Embodiments of the disclosure provide a communication method. Alternatively, the method may be applied to an STA. The method includes:
receiving a first wireless frame sent by a first AP; in which the first wireless frame includes initial access parameter information of a second AP.

Alternatively, the initial access parameter information includes at least one of:

MAC address information of the second AP, or a work link parameter of the second AP.

Alternatively, the second AP does not support multi-link communication, and the initial access parameter information includes a BSS parameter of the second AP.

Alternatively, the second AP supports multi-link communication, and the initial access parameter information includes a station information parameter of the second AP; and the work link parameter of the second AP is carried in the station information parameter.

Alternatively, the work link parameter of the second AP includes at least one of:
a link ID of a work link of the second AP, or an MAC address of the work link of the second AP.

Alternatively, the communication method also includes:
determining a probe request frame, in which the probe request frame includes first identification information, and the first identification information indicates the station requesting to obtain the device information of the first AP and device information of the second AP; and
sending the probe request frame.

Alternatively, the communication method also includes:
establishing an initial link with the first AP or the second AP based on the first wireless frame.

Alternatively, in embodiments of the disclosure, the first wireless frame includes at least one of:
a beacon frame, a probe response frame, or an association response frame.

In embodiments of the disclosure, the STA receives the first wireless frame sent by the first AP; in which the first wireless frame includes the initial access parameter information of the second AP, such that the STA may perform handover to another AP for communication when the communication condition of the AP associated with the STA changes, and a flow is not stopped in the data transmission, to meet the requirement of the UHR for the transmission rate and the requirement of the low-delay service for the time delay.

Referring to FIG. 5, based on the same principle as the method according to embodiments of the disclosure, embodiments of the disclosure also provide an electronic device. The electronic device is a first AP, and the electronic device includes:
a determining module 501, configured to determine a first wireless frame; in which the first wireless frame includes initial access parameter information of a second AP; and
a sending module 502, configured to send the first wireless frame.

Alternatively, in embodiments of the disclosure, the initial access parameter information includes at least one of:
medium access control (MAC) address information of the second AP, or a work link parameter of the second AP.

Alternatively, in embodiments of the disclosure, the second AP does not support multi-link communication, and the initial access parameter information includes a BSS parameter of the second AP.

Alternatively, in embodiments of the disclosure, the second AP supports multi-link communication, and the initial access parameter information includes a station information parameter of the second AP; and
the work link parameter of the second AP is carried in the station information parameter.

Alternatively, in embodiments of the disclosure, the work link parameter of the second AP includes at least one of:
a link identification (ID) of a work link of the second AP, or an MAC address of the work link of the second AP.

Alternatively, in embodiments of the disclosure, the electronic device includes:
a first sending module, configured to send device information of a first station establishing a link with the first AP to the second AP.

Alternatively, in embodiments of the disclosure, the device information of the first station includes at least one of:

MAC address information of the first station, MAC address information of a multi-link device to which the first station belongs, or work link information of the first station.

Alternatively, in embodiments of the disclosure, the electronic device includes:
a first receiving module, configured to receive a probe request frame sent by a second station; in which the probe request frame includes first identification information, and the first identification information indicates the second station requesting to obtain the device information of the first AP and device information of the second AP.

Alternatively, in embodiments of the disclosure, the first wireless frame includes at least one of:
a beacon frame, a probe response frame, or an association response frame.

Embodiments of the disclosure provide a communication device, applied to a first AP. The communication device includes:
a determining module, configured to determine a first wireless frame; in which the first wireless frame includes initial access parameter information of a second AP; and
a sending module, configured to send the first wireless frame.

The communication device also includes other modules of the electronic device in the above embodiments, which is not described in detail here.

Referring to FIG. 6, based on the same principle as the method according to embodiments of the disclosure, embodiments of the disclosure also provide an electronic device. The electronic device is an STA. The electronic device includes:
a receiving module 601, configured to receive a first wireless frame sent by a first AP; in which the first wireless frame includes initial access parameter information of a second AP.

Alternatively, in embodiments of the disclosure, the initial access parameter information includes at least one of:

MAC address information of the second AP, or a work link parameter of the second AP.

Alternatively, in embodiments of the disclosure, the second AP does not support multi-link communication, and the initial access parameter information includes a BSS parameter of the second AP.

Alternatively, in embodiments of the disclosure, the second AP supports multi-link communication, and the initial access parameter information includes a station information parameter of the second AP; and
the work link parameter of the second AP is carried in the station information parameter.

Alternatively, in embodiments of the disclosure, the work link parameter of the second AP includes at least one of:
a link ID of a work link of the second AP, or an MAC address of the work link of the second AP.

Alternatively, in embodiments of the disclosure, the electronic device includes:
a second determining module, configured to determine a probe request frame, in which the probe request frame includes first identification information, and the first identification information indicates the station requesting to obtain the device information of the first AP and device information of the second AP; and
a third sending module, configured to send the probe request frame.

Alternatively, in embodiments of the disclosure, the electronic device includes:
an association module, configured to establish an initial link with the first AP or the second AP based on the first wireless frame.

Alternatively, in embodiments of the disclosure, the first wireless frame includes at least one of:
a beacon frame, a probe response frame, or an association response frame.

Embodiments of the disclosure also provide a communication device, applied to an STA. The communication device includes:
a second receiving module, configured to receive a first wireless frame sent by a first AP; in which the first wireless frame includes initial access parameter information of a second AP.

The communication device also includes other modules of the electronic device in the above embodiments, which is not described in detail here.

In an alternative embodiment, embodiments of the disclosure also provide an electronic device. As illustrated in FIG. 7, the electronic device 700 illustrated in FIG. 7 may be a server and includes a processor 701 and a memory 703. The processor 701 is connected to the memory 703, for example, by a bus 702. Alternatively, the electronic device 700 may also include a transceiver 704. It should be noted that there is not only one transceiver 704 in practical application, and the structure of the electronic device 700 does not constitute a limitation to the embodiments of the disclosure.

The processor 701 may be a central processing unit (CPU), a general processor, a digital signal processor (DSP), an application specific integrated circuit (ASIC), a field programmable gate array (FPGA) or other programmable logic devices, transistor logic devices, hardware components or any combination thereof. The processor may implement or perform various illustrative logical blocks, modules, and circuits described with reference to the content of the disclosure. The processor 701 may also be a combination for realizing a computing function, for example, including one or more microprocessor combinations, DSP and microprocessor combinations, etc.

The bus 702 may include a path to transfer information between the above components. The bus 702 may be a peripheral component interconnect (PCI) bus or an extended industry standard architecture (EISA) bus. The bus 702 may be divided into an address bus, a data bus, a control bus, and the like. For the convenience of representation, the bus is described only by a thick line in FIG. 7, but it does not mean that there is only one bus or one type of bus.

The memory 703 may be a read only memory (ROM) or other types of static storage devices that may store static information and instructions, a random access memory (RAM) or other types of dynamic storage devices that may store information and instructions. The memory may also be an electrically erasable programmable read only memory (EEPROM), a compact disc read only memory (CD-ROM), or other optical storage, optical storage (including a compact disc, a laser disc, an optical disc, a digital versatile disc, a Blu-ray disc, etc.), a magnetic storage medium or other magnetic storage device, or any other medium that may be used to carry or store desired program codes in the form of instructions or data structures and can be accessed by a computer, but is not limited to this.

The memory 703 is configured to store application codes for executing the solution of the disclosure, and the execution of the application program codes is controlled by the processor 701. The processor 701 is configured to execute the application codes stored in the memory 703, to realize the contents illustrated in the above method embodiments.

The electronic device includes, but is not limited to, a mobile terminal such as a mobile phone, a notebook computer, a digital broadcast receiver, a personal digital assistant (PDA), a tablet computer (PAD), a portable multimedia player (PMP), a vehicle-mounted terminal (such as a vehicle-mounted navigation terminal) and a fixed terminal such as digital TV and a desktop computer. The electronic device illustrated in FIG. 7 is only an example, and should not bring any limitation to the function and application scope of embodiments of the disclosure.

The server provided by the disclosure can be an independent physical server, a server cluster or a distributed system contributed by multiple physical servers; and a cloud server that provides a basic cloud computing service such as a cloud service, a cloud database, cloud computing, a cloud function, cloud storage, a network service, cloud communication, a middleware service, a domain name service, a security service, CDN, big data and an artificial intelligence platform. The terminal may be a smart phone, a tablet, a notebook computer, a desktop computer, a smart speaker, a smart watch, etc., but is not limited to this. The terminal and the server may be directly or indirectly connected through wired or wireless communication, which is not limited here in the disclosure.

Embodiments of the disclosure provide a computer-readable storage medium. The computer-readable storage medium has a computer program stored. When the computer program is run on a computer, the computer is enabled to execute the corresponding contents in the above method embodiments.

It should be understood that, although steps in the flow chart of the accompanying drawings are illustrated in sequence as indicated by arrows, these steps are not necessarily executed in sequence as indicated by arrows. Unless explicitly stated herein, the execution of these steps is not strictly limited in order, and these steps can be executed in other orders. Moreover, at least some of the steps in the flow chart of the accompanying drawings may include multiple sub-steps or stages, which may not necessarily be completed at the same time, but may be executed at different time moments, and the execution order of the sub-steps or stages may not necessarily be sequential, but may be executed alternately or alternatively with other steps or at least some of sub-steps or stages of other steps.

It should be noted that the computer-readable medium mentioned above in the disclosure may be a computer-readable signal medium or a computer-readable storage medium or any combination thereof. The computer-readable storage medium may be, for example, but not limited to, an electrical, magnetic, optical, electromagnetic, infrared, or a semiconductor system, apparatus or device, or a combination of any of the above. More specific examples of the computer-readable storage medium may include, but not limited to, an electrical connection with one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above. In this disclosure, the computer-readable storage medium may be any tangible medium including or storing a program. The program may be used by or in combination with an instruction execution system, apparatus or device. In the disclosure, the computer-readable signal medium may include a data signal propagated in a baseband or as part of a carrier wave, in which computer-readable program codes are carried. The propagated data signal may take multiple forms, including but not limited to, an electromagnetic signal, an optical signal or any suitable combination of the above. The computer-readable signal medium may also be any computer-readable medium other than the computer-readable storage medium. The computer-readable signal medium may send, propagate or transmit a program for use by or in combination with the instruction execution system, apparatus or device. The program codes included in the computer-readable medium may be transmitted by any suitable medium, including but not limited to: wires, optical cables, RF (radio frequency) and the like, or any suitable combination of the above.

The computer-readable medium may be included in the electronic device; or may exist alone without being assembled into the electronic device.

The computer-readable medium carries one or more programs. When the one or more programs are executed by the electronic device, the electronic device is caused to perform the method illustrated in the above embodiments.

According to an aspect of the disclosure, there is provided a computer program product or computer program. The computer program product or computer program includes computer instructions stored in a computer-readable storage medium. A processor of a computer device reads the computer instructions from the computer-readable storage medium, and the processor executes the computer instructions, such that the computer device performs the methods provided in the various alternative implementations described above.

Computer program codes for performing the operations of the disclosure may be written in one or more program languages or a combination thereof. The program languages include object-oriented programming languages, such as Java, Smalltalk, C++, also include conventional procedural programming languages, such as the C programming language or similar programming languages. The computer readable program instructions may execute entirely on the computer of the user, partly on the computer of the user, as a stand-alone software package, partly on the computer of the user and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet service provider).

The flow charts and block diagrams in the accompanying drawings illustrate the architecture, functions and operations of possible implementations of systems, methods and computer program products based on various embodiments of the disclosure. In this regard, each block in the flow chart or block diagram may represent a module, a program segment, or a part of codes that includes one or more executable instructions for implementing specified logical functions. It should also be noted that, in some alternative implementations, the functions noted in the blocks may occur in a different order than those noted in the accompanying drawings. For example, two blocks illustrated in succession may actually be executed substantially in parallel, and may sometimes be executed in the reverse order, depending on the functions involved. It should also be noted that each block in the block diagrams and/or flow charts, and combinations of blocks in the block diagrams and/or flow charts, may be implemented by a dedicated hardware-based system that performs specified functions or operations, or by a combination of dedicated hardware and computer instructions.

The modules described in embodiments of the disclosure may be implemented in software or in hardware. The name of the module does not constitute the limitation of the module itself in some cases. For example, module A can also be described as “module A for performing B operation”.

The above description is only the preferred embodiment of the disclosure and the explanation of the applied technical principles. It should be understood by those skilled in the art that the disclosure scope involved in the disclosure is not limited to the technical solution formed by the specific combination of the above technical features, but also covers other technical solution formed by any combination of the above technical features or their equivalent features without departing from the above disclosure concept. For example, the technical solution may be formed by replaced the above features with (but not limited to) technical features with similar functions disclosed in the disclosure.

1. A communication method, performed by a first access point (AP), comprising:
determining a first wireless frame; wherein the first wireless frame comprises initial access parameter information of a second AP; and
sending the first wireless frame.

2. The communication method of claim 1, wherein the initial access parameter information comprises at least one of:
medium access control (MAC) address information of the second AP, or a work link parameter of the second AP.

3. The communication method of claim 1, wherein the second AP does not support multi-link communication, and the initial access parameter information comprises a basic service set (BSS) parameter of the second AP.

4. The communication method of claim 2, wherein the second AP supports multi-link communication, and the initial access parameter information comprises a station information parameter of the second AP; and
the work link parameter of the second AP is carried in the station information parameter.

5. The communication method of claim 4, wherein the work link parameter of the second AP comprises at least one of:
a link identification (ID) of a work link of the second AP, or an MAC address of the work link of the second AP.

6. The communication method of claim 1, further comprising:
sending device information of a first station establishing a link with the first AP to the second AP,
wherein the device information of the first station comprises at least one of:
MAC address information of the first station, MAC address information of a multi-link device to which the first station belongs, or work link information of the first station.

7. (canceled)

8. The communication method of claim 1, wherein before sending the first wireless frame,
the communication method further comprises:
receiving a probe request frame sent by a second station; wherein the probe request frame comprises first identification information, and the first identification information indicates the second station requesting to obtain the device information of the first AP and device information of the second AP.

9. The communication method of claim 1, wherein the first wireless frame comprises at least one of:
a beacon frame, a probe response frame, or an association response frame.

10. A communication method, performed by a station (STA), comprising:
receiving a first wireless frame sent by a first access point (AP); wherein the first wireless frame comprises initial access parameter information of a second AP.

11. The communication method of claim 10, wherein the initial access parameter information comprises at least one of:
medium access control (MAC) address information of the second AP, or a work link parameter of the second AP.

12. The communication method of claim 10, wherein the second AP does not support multi-link communication, and the initial access parameter information comprises a basic service set (BSS) parameter of the second AP.

13. The communication method of claim 11, wherein the second AP supports multi-link communication, and the initial access parameter information comprises a station information parameter of the second AP, and
the work link parameter of the second AP is carried in the station information parameter.

14. The communication method of claim 13, wherein the work link parameter of the second AP comprises at least one of:
a link identification (ID) of a work link of the second AP, or an MAC address of the work link of the second AP.

15. The communication method of claim 10, wherein before receiving the first wireless frame sent by the first AP, the communication method further comprises:
determining a probe request frame, wherein the probe request frame comprises first identification information, and the first identification information indicates the station requesting to obtain the device information of the first AP and device information of the second AP; and
sending the probe request frame.

16. The communication method of claim 10, wherein, after receiving the first wireless frame sent by the first AP, the communication method further comprises:
establishing an initial link with the first AP or the second AP based on the first wireless frame.

17. The communication method of claim 10, wherein the first wireless frame comprises at least one of:
a beacon frame, a probe response frame, or an association response frame.

18. A first access point (AP), comprising:
a processor; and
a memory storing executable instructions by the processor,
wherein the processor is configured to:
determine a first wireless frame; wherein the first wireless frame comprises initial access parameter information of a second AP; and
send the first wireless frame.

19. A station (STA), comprising:
a processor; and
a memory storing executable instructions by the processor,
wherein the processor is configured to execute the method of claim 10.

20. (canceled)

21. A non-transitory computer-readable storage medium, wherein a computer program is stored on the computer-readable storage medium, and the computer program is configured to realize the communication method of claim 1 when executed by a processor.

22. A non-transitory computer-readable storage medium, wherein a computer program is stored on the computer-readable storage medium, and the computer program is configured to realize the communication method of claim 10 when executed by a processor.
